(19) United States
(12) Patent Application Publication
(10) Pub. No.: US 2021/0088071 A1
(43) Pub. Date: Mar. 25, 2021

(54) NUT

(71) Applicant: Kaoru TANEICHI, Kanagawa (JP)

(72) Inventor: Kaoru TANEICHI, Kanagawa (JP)

(21) Appl. No.: 16/634,446

(22) PCT Filed: Aug. 3, 2017
(86) PCT No.: PCT/JP2017/028301

§ 371 Date: Jan. 27, 2020

(51) Int. Cl. F16B 37/08; F16B 43/00

(52) U.S. Cl. CPC F16B 37/0857; F16B 43/00

(57) ABSTRACT

The nut is configured by: a nut main body that includes a plurality of nut segment housing portions; a plurality of nut segments that are respectively housed in the nut segment housing portions of the nut main body: an urging means that is provided above the nut segments and urges the nut segments in a bottom surface direction of the nut main body; and a holding means that holds the nut segments and the urging means inside the nut main body. In the nut, a step is formed in a bottom surface of the nut segment housing portion such that screw portions formed on inner sides of the nut segments are continuous. In addition, a guide portion is formed in the nut segment housing portion, and a guide piece that is inserted into the guide portion and slides the nut segment only in a linear direction is provided in the nut segment.

### BACKGROUND OF THE INVENTION

### 1. Field of the Invention

The present invention relates to a nut that includes a plurality of nut segments that move in a sliding manner in an axial direction.

### 2. Description of the Related Art

Conventionally, as a nut into which a bolt can be pushed and fastened, “a push nut that is characterized by being configured by: a nut main body of which an outer wall is formed into a polygonal shape, and that has a sloped hole of which an inner diameter gradually becomes a reduced dimension and a small-diameter end portion forms two or more steps; two or more nut segments that are capable of moving in a sliding manner inside the sloped hole of the nut main body, of which an end portion on a small diameter side comes into contact with a stepped portion, and a pressing protruding piece is formed in an end portion on a large diameter side; a screw portion that is formed on inner wall surfaces of the two or more nut segments such as to be continuous with a nut segment that is in contact with a stepped portion of a smallest diameter; a washer that is provided in the end portions on the large diameter side of the two or more nut segments; an urging spring that is attached inside the nut main body such as to urge the two or more nut segments toward the small diameter side at all times, with the washer therebetween; and a stopper piece that is attached to the nut main body and in which a bolt insertion hole that holds the urging spring inside the nut main body is formed” is known.

However, in a nut such as this, when the bolt is pushed into the nut, the nut segments move toward the large diameter side against an urging force of the urging spring. However, in this case, the nut segments slightly rotate. The screw portion becomes tilted. A disadvantage in that the screw portions of the nut and the bolt do not smoothly mesh arises. In addition, a plurality of nuts do not accurately mesh together.

[Patent Literature 1] Japanese Patent Laid-open Publication No. 2013-234731

### SUMMARY OF THE INVENTION

In light of conventional disadvantages such as those described above, an object of the present invention is to provide a nut that is smoothly screwed onto a bolt, without nut segments becoming tilted when the bolt is pushed into the nut.

The object described above, other objects, and novel features of the present invention will become more completely clear when the following description is read with reference to the accompanying drawings.

However, the drawings are mainly for description and do not limit the technical scope of the present invention. To achieve the above-described object, a nut of the present invention is configured by: a nut main body that includes a plurality of nut segment housing portions; a plurality of nut segments that are respectively housed in the nut segment housing portions of the nut main body: an urging means that is provided above the nut segments and urges the nut segments in a bottom surface direction of the nut main body; and a holding means that holds the nut segments and the urging means inside the nut main body. The nut is characterized in that a step is formed in a bottom surface of the nut segment housing portion such that screw portions formed on inner sides of the nut segments are continuous. In addition, a guide portion is formed in the nut segment housing portion, and a guide piece that is inserted into the guide portion and slides the nut segment only in a linear direction is provided in the nut segment.

### EFFECTS OF THE INVENTION

As is clear from the description above, the present invention achieves the effects listed below:

(1) According to a first aspect and a second aspect of the invention, the nut segments are guided by the guide portions and the guide pieces when the nut segments move upward. Therefore, the nut segments can be prevented from rotating.

Consequently, the nut can be smoothly screwed onto the bolt when the bolt is pushed into the nut.

In addition, because the nut segments are lifted upward in a parallel state and a diameter of the screw portion increases, the nut segments seizing to a screw portion of the bolt can be prevented.

(2) According to a third aspect of the invention as well, effects similar to above-described (1) can be achieved. In addition, because the guide piece is inserted into the guide portion that is a linear groove, the nut segments can be prevented from detaching from the nut main body during nut assembly. (3) According to a fourth aspect of the invention as well, effects similar to above-described (1) and (2) can be achieved. In addition, because a washer member is provided, the nut itself can be easily fixed to wood, iron, or the like, and used.

### BRIEF DESCRIPTION OF THE DRAWING

FIG. 1 to FIG. 7 are explanatory diagrams according to a first embodiment of the present invention.

FIG. 8 to FIG. 11 are explanatory diagrams according to a second embodiment of the present invention.

FIG. 12 and FIG. 13 are explanatory diagrams according to a third embodiment of the present invention.

FIG. 14 and FIG. 15 are explanatory diagrams according to a fourth embodiment of the present invention.

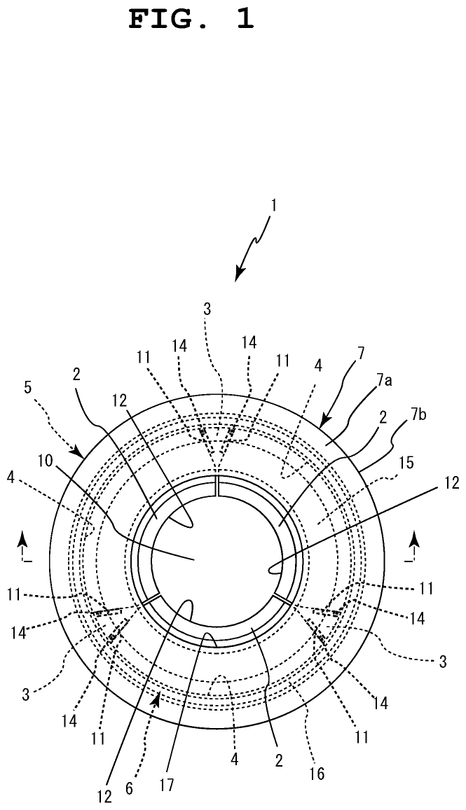

FIG. 1 is a planar view of a nut according to a first embodiment;

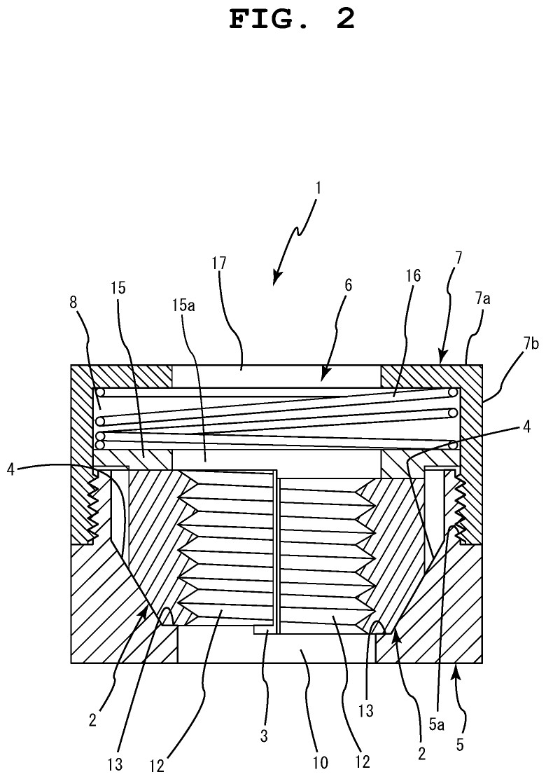

FIG. 2 is a cross-sectional view taken along line 2-2 in FIG. 1;

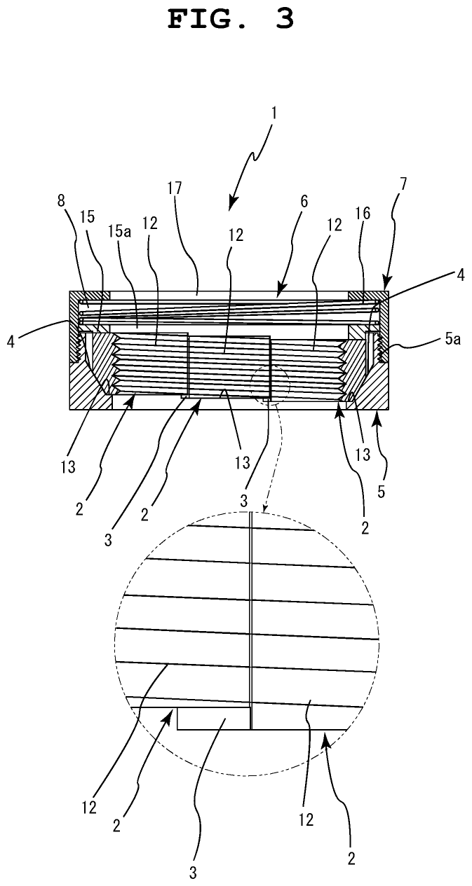

FIG. 3 is a developed view of the nut;

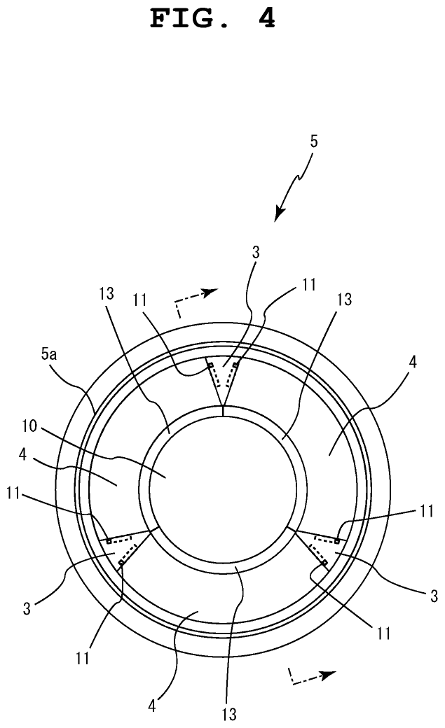

FIG. 4 is a planar view of a nut main body;

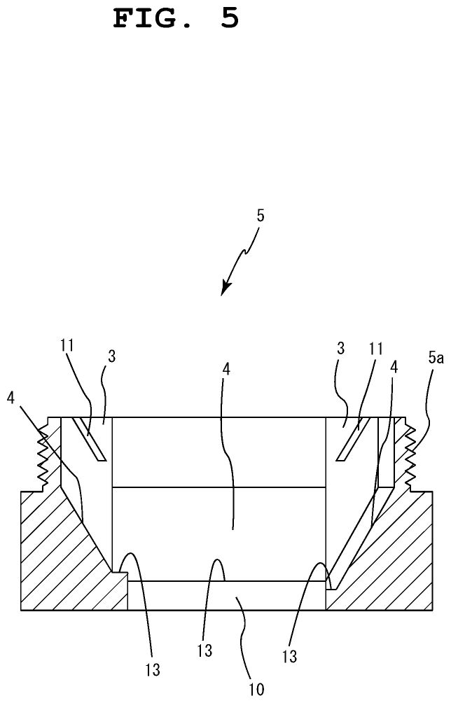

FIG. 5 is a cross-sectional view taken along line 5-5 in FIG. 4;

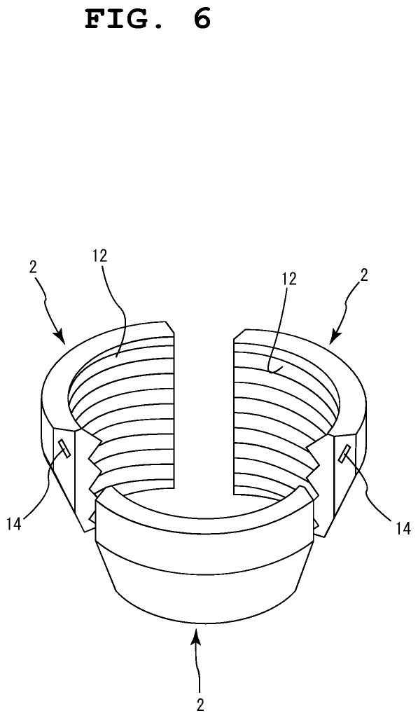

FIG. 6 is an explanatory perspective view of nut segments;

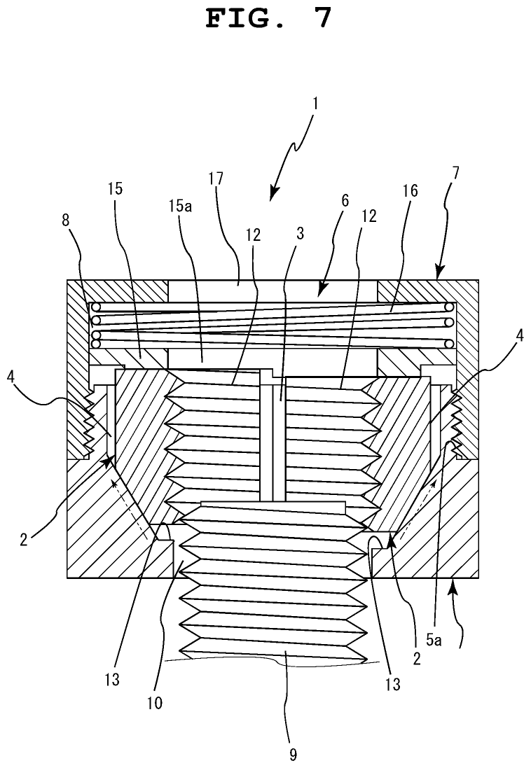

FIG. 7 is an explanatory diagram of a state in which a bolt is inserted;

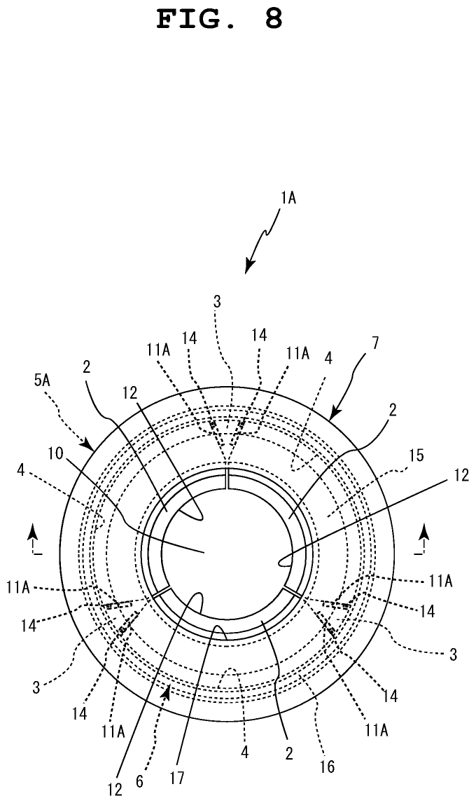

FIG. 8 is a planar view of a nut according to a second embodiment;

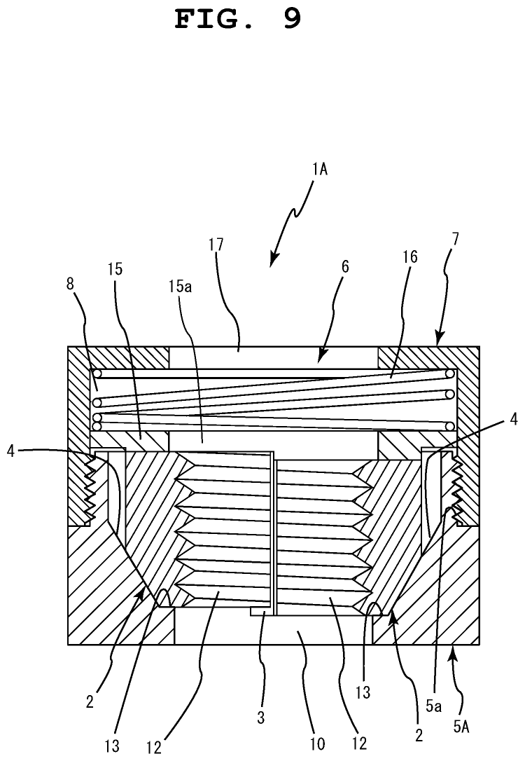

FIG. 9 is a cross-sectional view taken along line 9-9 in FIG. 8;

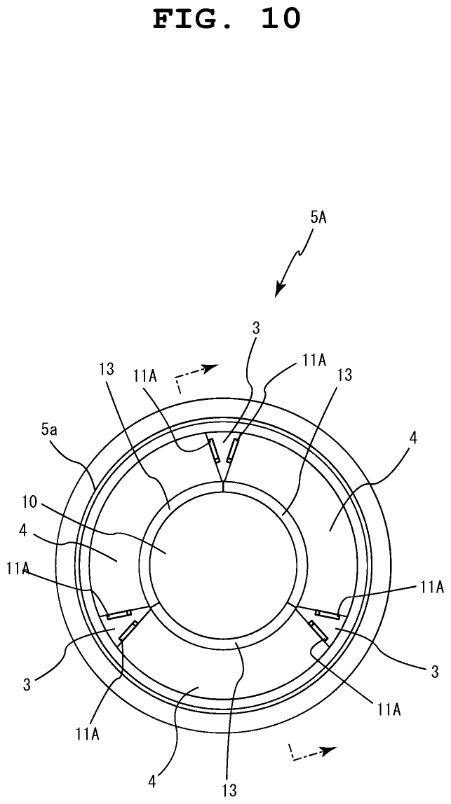

FIG. 10 is a planar view of a nut main body;

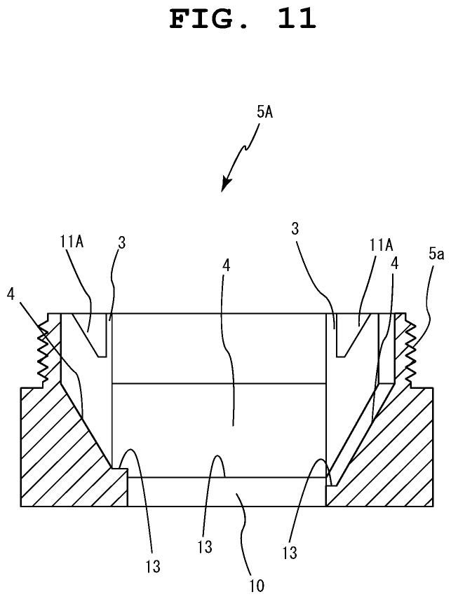

FIG. 11 is a cross-sectional view taken along line 11-11 in FIG. 10;

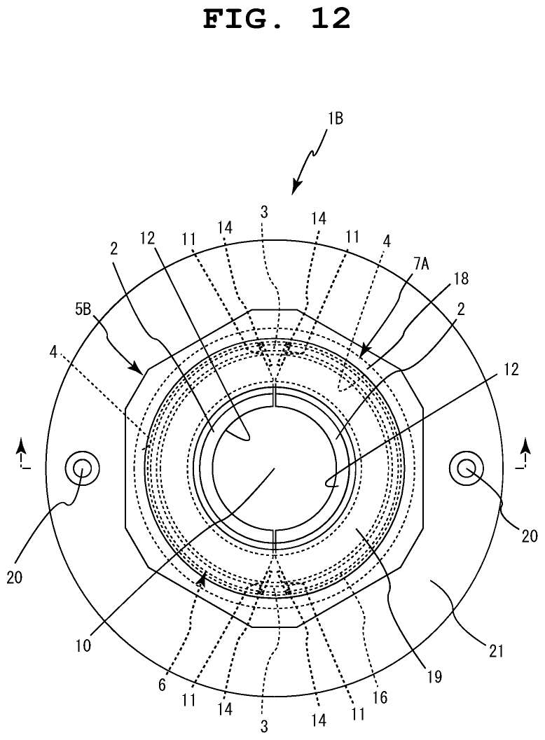

FIG. 12 is a planar view of a nut according to a third embodiment;

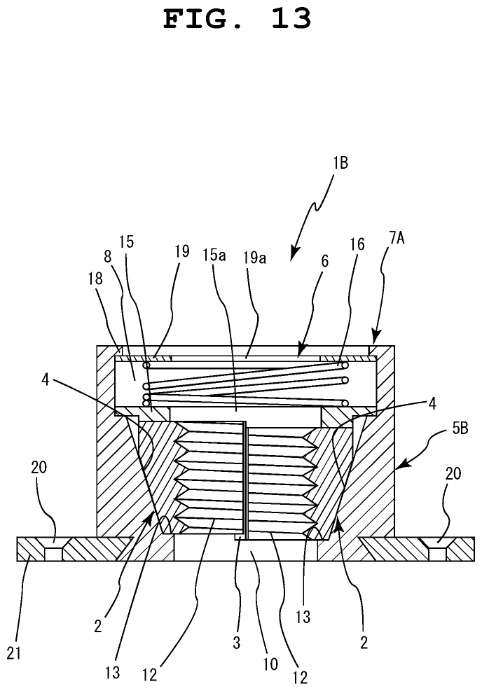

FIG. 13 is a cross-sectional view taken along line 13-13 in FIG. 12;

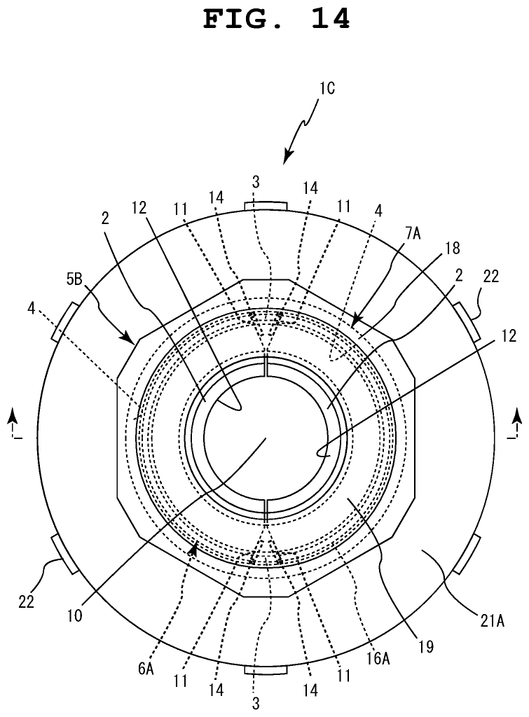

FIG. 14 is a planar view of a nut according to a fourth embodiment; and

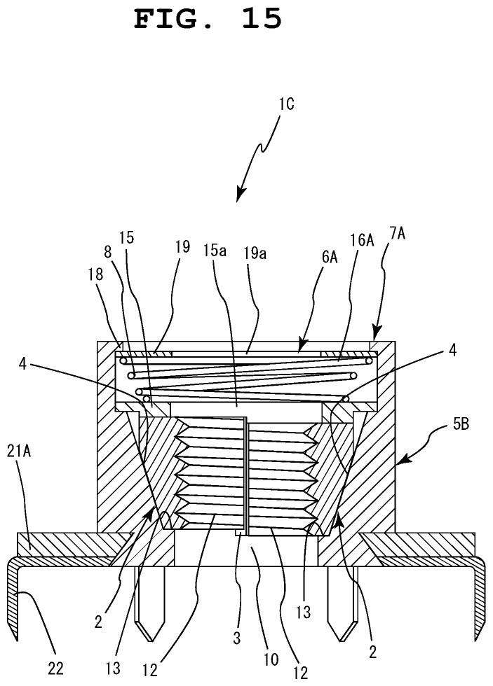

FIG. 15 is a cross-sectional view taken along line 15-15 in FIG. 14.

### EXPLANATION OF REFERENCE NUMBERS

1, 1A, 1B, 1C: nut

2: nut segment

3: partition wall

4: nut segment housing portion

5, 5A, 5B: nut main body

6, 6A: urging means

7, 7A: holding means

8: urging means housing portion

9: bolt

10: bolt through-hole

11, 11A: guide portion

12: screw portion

13: bottom surface

14: guide piece

15: pressing plate

16, 16A: urging spring

17: through hole

18: crimped portion

19: washer

20: screw hole

21, 21A: washer member

22: tab

### DETAILED DESCRIPTION OF THE PREFERRED EMBODIMENTS

The present invention will hereinafter be described in detail based on embodiments for carrying out the present invention shown in the drawings. Here, in the present specification, the description will be given such that, with reference to FIG. 2 (front view), an upper side is upward and a lower side is downward.

According to a first embodiment for carrying out the present invention shown in FIG. 1 to FIG. 7, reference number 1 represents a nut that includes a plurality of nut segments 2 that move in a sliding manner in an axial direction.

As shown in FIG. 1 and FIG. 2, the nut 1 is configured by: a nut main body 5 inside which a plurality of nut segment housing portions 4 that are separated by partition walls 3 are formed; nut segments 2 that are respectively housed in the nut segment housing portions 4 of the nut main body 5; an urging means 6 that is provided above the nut segments 2 and urges the nut segments 2 downward; and a cylindrical holding means 7 that holds the nut segments 2 and the urging means 6 inside the nut main body 5.

According to the present embodiment, the nut main body 5 is composed of iron. As shown in FIG. 4 and FIG. 5, an outer shape of the nut main body 5 formed such as to be circular from a planar view. The plurality of nut segment housing portions 4 are formed inside the nut main body 5. The plurality of nut segment housing portions 4 are separated by a total of three partition walls 3 that are provided at a predetermined interval in a circumferential direction and of which a portion of a wall surface in a radial direction is a sloped surface.

According to the present embodiment, the partition walls 3 are integrally formed inside the nut main body 5. However, partition walls 3 that are freely detachable may be provided in the nut main body 5. Specifically, attachment grooves or the like may be formed on an inner circumferential surface of the nut main body 5. The partition walls 3 may be attached and detached through use of partition walls 3 that each include an engaging piece that engages with the attachment groove.

In addition, only a lower portion of the partition wall 3 may be integrally formed in the nut main body 5. Only a portion of the partition wall 3 that includes a guide portion 11 may be freely detachable.

As shown in FIG. 2, an upper space portion in which the urging means 6 is housed is formed above the nut segment housing portions 4, that is, inside a cap-shaped holding means 7. The upper space portion serves as an urging means housing portion 8.

A bolt through-hole 10 into which a bolt 9 is inserted is formed in a bottom surface of the nut main body 5.

Furthermore, according to the present embodiment, a screw portion 5a for attaching the holding means 7, described hereafter, is formed in an outer circumferential portion near an upper portion of the nut main body 5.

The groove-shaped guide portion 11 is formed in each of the partition walls 3 that are provided in appropriate parts of both side portions or a side wall portion of the nut segment housing portions 4.

According to the present embodiment, the guide portion 11 is formed into a linear groove that is sloped. A slope angle of the guide portion 11 is substantially the same as an angle of a slope surface of the nut segment housing portion 4. Therefore, the nut segments 2 can move upward in a parallel state, without rotating.

A step is provided on a bottom surface 13 of the nut segment housing portion 4, such that screw portions 12 of adjacent nut segments 2 are continuously connected. As a result of such a step being formed, as shown in FIG. 3, even when the same nut segments 2 are used, because the screw portions 12 of adjacent nut segments 2 are continuously connected, the nut 1 is able to function as a nut regardless of which nut segment 2 is housed in which nut segment housing portion 4.

Therefore, the screw portions 12 not being continuous as a result of an assembly error and the nut 1 being unable to function as a nut can be prevented. Because the same nut segments 2 can be used, all that is required is that a single type of nut segment 2 be manufactured. Cost can be reduced. The nut segment 2 is composed of iron. As shown in FIG. 6, in the nut segment 2, a lower portion of an outer circumferential surface thereof is formed into a sloped surface. The screw portion 12 is provided on an inner circumferential surface of the nut segment 2. According to the present embodiment, the screw portion 12 that screws onto the bolt 9 is formed through use of three nut segments 2.

In addition, guide pieces 14 that are each inserted into the guide portion 11 are provided on both side surfaces of the nut segment 2. The guide piece 14 is a protruding piece that is sloped at substantially the same angle as the guide portion 11, and is inserted into the guide portion 11 during assembly. The partition wall 3 in which the guide portion 11 is formed such as to be substantially triangular from a planar view. When the nut segments 2 are pushed upward, the nut segments 2 can move upward while maintaining a parallel state. In addition, the guide pieces 14 are prevented from detaching in a lateral direction.

In addition, as a result of the partition walls 3 being formed such as to be substantially triangular from a planar view, when the nut segments 2 are pushed upward, the nut segments 2 move in a sliding manner in an obliquely upper portion direction by the guide portions 11. However, even when the nut segments 2 move in this manner, a state in which both side portions of the nut segment 2 and the partition walls 3 are substantially in contact at all times (a state in which both side portions of the nut segment 2 and the partition walls 3 are in very close contact or in close proximity with only a slight gap therebetween) can be maintained. The guide pieces 14 can be prevented from detaching in the lateral direction.

According to the present embodiment, the partition wall 3 is formed such as to be substantially triangular from a planar view. However, the partition wall 3 can have any shape as long as the shape is such that both side portions of the nut segment 2 and the partition walls 3 are substantially in contact at all times.

In addition, in the nut segment 2 as well, the portion that is substantially in contact with the partition wall 3 is cut at an angle.

As a result of the guide piece 14 being inserted into the sloped guide portion 11, for example, even when the nut main body 5 is tilted during assembly, the nut segments 2 can be prevented from detaching from the nut main body 5.

Here, according to the present embodiment, the nut segments 2 and the nut main body 5 that are composed of iron are used. However, the nut segments 2 and the nut main body 5 may be composed of a resin (such as an engineering plastic, in particular), a metal alloy, a non-iron metal, a ceramic, or the like.

The urging means 6 is configured by an iron pressing plate 15 and an urging spring 16 that are housed in the urging means housing portion 8. The pressing plate 15 comes into contact with upper surfaces of the nut segments 2, and has a through hole 15a in a center portion. The urging spring 16 urges the pressing plate 15 such as to press the pressing plate 15 downward.

According to the present embodiment, as the urging spring 16, a single coil spring of which an inner diameter is greater than a bolt diameter is used. However, the urging spring 16 may be configured such that a plurality of small-diameter coil springs are provided on an upper surface of the pressing plates 15.

When the bolt 9 is inserted into the nut 1, the nut segments 2 are lifted obliquely upward. However, the nut segments 2 are pressed downward by the urging means 6 and substantially returned to an initial position. In addition, the nut segments 2 screw onto the bolt 9 without rotating (in a parallel state).

A bottom surface of the pressing plate 15 is formed such as to have a stepped shape, and comes into contact with the upper surface of each nut segment 2. As a result of the bottom surface of the pressing plate 15 having the stepped shape in this manner, the plurality of nut segments 2 can be uniformly urged downward.

According to the present embodiment, as the holding means 7, an iron lid body 7 that screws onto the screw portion 5a that is formed in the upper portion of the nut main body 5 is used.

As shown in FIG. 1 and FIG. 2, the lid body 7 is a cylindrical member that is composed of an annular wall portion 7a that corresponds to a part of an upper wall portion, and a circumferential wall portion 7b that continues from an outer circumferential end of the annular wall portion 7a. A through hole 17 through which the bolt 9 passes is formed on an inner circumferential end side of the annular wall portion 7a, that is, a center portion of the lid body 7. In other words, the lid body 7 is formed into a shape that is similar to a so-called cap nut. An outer diameter of the lid body 7 is substantially the same as the outer diameter of the nut main body 5, and is formed such as to be circular from a planar view.

Here, according to the present embodiment, the pressing plate 15 and the lid body 7 are composed of iron. However, a resin, a non-iron metal, a metal alloy, a ceramic, or the like may be used.

For example, the nut 1 of the present invention is used in wooden housing, iron structures, concrete structures, and the like. Moreover, the nut 1 can also be used in various types of equipment, such as equipment for use in outer space, aviation equipment, nautical equipment, and the like.

When the nut 1 is used, the bolt 9 that is protruding from a piece of lumber is inserted into the bolt through-hole 10. As a result, the nut segments 2 are pressed by the bolt 9 from below, and move upward against the urging force of the urging means 6.

At this time, because the guide pieces 14 are inserted into the guide portions 11, the nut segments 2 are pressed obliquely upward along the slope of the guide portions 11. That is, the nut segments 2 move upward as the diameter of the screw portion 12 on the inner side widens. When the nut segments 2 move in this manner, because the nut segments 2 are guided by the guide portions 11 and the guide pieces 14, the nut segments 2 do not rotate around an intersecting portion between a straight portion and a sloped portion of the outer circumferential surface. The nut segments 2 are slid only in a linear direction, and can be smoothly moved upward.

In addition, because the partition walls 3 are formed such as to be substantially triangular from a planar view, even when the nut segments 2 are lifted in the direction in which the diameter of the screw portion 12 widens, both side portions of the nut segments 2 and the partition walls 3 are substantially in contact at all times. The guide pieces 14 detaching from the guide portions 11, and the nut segments 2 moving upward without being guided by the guide portions 11 can be prevented.

Consequently, the screw portion 12 seizing on the bolt 9 or getting caught on the bolt 9 at an unintended position, and the bolt 9 becoming unable to smoothly pass through the nut 1 and the like can be prevented.

Here, the nut segment 2 is designed so as not to move upward by an amount that is equal to or greater than 1.5 threads of the threads of the screw portion 12. As a result of the bolt 9 pressing the nut segments 2, the nut segments 2 move upward. However, because the nut segments 2 accurately move over each thread, even when the bolt 9 is appropriately pushed into the nut 1 and stopped, the plurality of nut segments 2 are accurately coupled with the bolt 9 at the bolt pitch of the bolt 9.

When the diameter of the screw portion 12 widens to an extent that the bolt 9 is able to pass, the bolt 9 passes through the nut 1. When this state is achieved, the nut 1 is rotated in a fastening direction. The nut 1 and the bolt 9 are firmly fastened.

Here, according to the present embodiment, the nut main body 5 and the like are circular from a planar view (the outer shape is a circular columnar shape). Therefore, a jig attaching portion (not shown) or the like may be provided in the nut main body 5 or the like. Tightening and the like may be performed through use of the jig.

In addition, an engaging piece (not shown) maybe provided in a lower portion of the nut main body 5 of the nut 1. The engaging piece may be engaged with a washer member, and the nut 1 may be fixed to a piece of lumber or the like.

[Other Embodiments for Carrying Out the Invention]

Next, other embodiments for carrying out the present invention will be described with reference to FIG. 8 to FIG. 15. Regarding the descriptions of the other embodiments for carrying out the present invention, constituent sections that are identical to those according to the above-described first embodiment for carrying out the present invention are given the same reference numbers. Redundant descriptions are omitted.

A second embodiment for carrying out the present invention, shown in FIG. 8 to FIG. 11, mainly differs from the first embodiment for carrying out the present invention in that a nut main body 5A in which a guide portion 11A that has a hollow shape is formed in the partition wall 3 is provided. Even when a nut 1A such as this is used, working effects similar to those according to the above-described first embodiment for carrying out the invention can be achieved.

A third embodiment for carrying out the present invention, shown in FIG. 12 and FIG. 13, mainly differs from the first embodiment for carrying out the present invention in that a metal nut main body 5B in which two nut segment housing portions 4 are formed and of which the outer shape is a hexagon is provided. Two metal nut segments 2A are housed in the nut segment housing portions 4. In addition, a holding means 7A that is configured by a crimped portion 18 in which an upper portion of the nut main body 5B is crimped inward and a washer 19 that has a through hole 19a and is provided between the crimped portion 18 and the urging spring 16 is used. A washer member 21 that has screw holes 20 is rotatably provided in a lower portion of the nut main body 5B. Even when a nut 1B such as this is used, working effects similar to those according to the above-described first embodiment for carrying out the invention can be achieved.

Here, according to the present embodiment, an aspect in which the washer member 21 is rotatably provided in the nut main body 5B is described. However, the washer member 21 may be integrally formed with the nut main body 5B.

A fourth embodiment for carrying out the present invention, shown in FIG. 14 and FIG. 15, mainly differs from the third embodiment for carrying out the present invention in that an urging means 6A that uses a conical spring 16A of which a diameter increases in an upward direction is provided. In addition, a washer member 21A that does not include screw holes and includes tabs 22 for temporary fixing to a piece of lumber or the like is provided. Even when a nut 1C such as this is used, working effects similar to those according to the above-described first embodiment for carrying out the invention can be achieved.

Here, according to the embodiments of the present invention, aspects in which two or three nut segments are used are described. However, all that is required is that a plurality of nut segments be provided. For example, four, six, or eight nut segments may be used.

In addition, a configuration in which the guide portions are formed in the partition walls is described. However, the guide portion may be formed in a part of the nut segment housing portion that comes into contact with an outer side surface of the nut segment (a side surface on which the screw portion is not formed), and the guide piece may be formed on an outer side surface of the nut segment.

### INDUSTRIAL APPLICABILITY

The present invention is used in an industry for manufacturing nuts.

1. A nut comprising:
a nut main body that includes a plurality of nut segment housing portions;
a plurality of nut segments that are respectively housed in the nut segment housing portions of the nut main body:
an urging means that is provided above the nut segments and urges the nut segments in a bottom surface direction of the nut main body; and
a holding means that holds the nut segments and the urging means inside the nut main body, wherein
a step is formed in a bottom surface of the nut segment housing portion such that screw portions formed on inner sides of the nut segments are continuous, and
a guide portion is formed in the nut segment housing portion, and a guide piece that is inserted into the guide portion and slides the nut segment only in a linear direction is provided in the nut segment.

2. The nut according to claim 1, wherein:
the nut segment housing portions are separated by partition walls, and the guide portion is formed in the partition wall.

3. The nut according to claim 1, wherein:
the guide portion is a linear groove that is sloped.

4. The nut according to claim 1, wherein:
a washer member is provided in a lower portion of the nut main body.
